(19) United States
(12) Patent Application Publication
(10) Pub. No.: US 2019/0108082 A1
(43) Pub. Date: Apr. 11, 2019

(54) MANAGEMENT SYSTEM, MANAGEMENT APPARATUS, AND MANAGEMENT METHOD

(71) Applicant: HITACHI, LTD., Tokyo (JP)

(72) Inventors: Shotaro TANAKA, Tokyo (JP); Maki TSUDA, Tokyo (JP); Taiki EIRAKU, Tokyo (JP); Shingo KATANO, Tokyo (JP)

(21) Appl. No.: 16/081,057

(22) PCT Filed: Jan. 13, 2017
(86) PCT No.: PCT/JP2017/001120

§ 371 Date: Aug. 30, 2018

(51) Int. Cl. G06F 11/07

(52) U.S. Cl. CPC G06F 11/079; G06F 11/0751; G06F 11/0709

(57) ABSTRACT

A management system with high maintainability capable of promptly achieving fault recovery is provided. The management system includes: a storage unit that stores event information of events, which have occurred in each of the plurality of applications, and related information indicative of a relation between applications with respect to the plurality of applications; an input unit that inputs information of an application which is an analysis origin from among the plurality of applications; an identification unit that identifies applications related to the application, which is the analysis origin, based on the related information stored in the storage unit; and an extraction unit that extracts the event information of the application, which is the analysis origin, and the event information of the related applications from the event information stored in the storage unit.

### TECHNICAL FIELD

The present invention relates to a management system, a management apparatus, and a management method and is suited for use in, for example, a management system, management apparatus, and management method for extracting event information related to an application that is an analysis origin.

BACKGROUND ART

As the scale of information systems has been expanded, many pieces of hardware and software are combined to be operated and the relation between them has become complicated. If a fault occurs in an information system under such circumstances, it becomes difficult to identify the fault location and the information system cannot be recovered promptly. For example, when faults occur in the information system, fault events are checked one by one on an event console screen on which the fault events are displayed, the status of equipment is checked in accordance with a maintenance manual which is designed in advance, the cause of the relevant fault event is identified, and some task of, for example, attaching a solved label to the fault event which has been dealt with is performed.

When a fault of hardware needs to be checked, whether the fault exists or not can be judged sequentially by monitoring performance history which the relevant hardware has. Furthermore, when the range of influences is to be checked and factors are to be analyzed upon the occurrence of a fault, an event which has occurred in the hardware and exceeds a threshold value is designated as an origin, other pieces of hardware to which the relevant hardware is connected are extracted, and those which have a high degree of relevance with the performance history of the relevant hardware are searched for.

In recent years, there has been disclosed a technique that narrows down elements which are display targets (components of a computer system) in order to guess what conditions should be used to narrow down the cause of a fault when the fault whose cause is unknown has occurred (see PTL 1).

### CITATION LIST

### Patent Literature

PTL 1: Japanese Patent No. 5957570

### SUMMARY OF THE INVENTION

### Problems to be Solved by the Invention

However, the technique described in PTL 1 can narrow down physical nodes, logical nodes, physical components, and logical components, but it cannot narrow down applications.

Furthermore, regarding applications, there is no information such as the performance history of the hardware based on which fault events can be judged sequentially. So, if a fault event occurs in an application, the above-mentioned fault event cannot be designated as the origin unlike the case of the hardware and, therefore, it is impossible to judge whether a fault exists or not, check the range of influences, or analyze the factors.

Specifically speaking, since an application which is an analysis target is related to other applications, the relevant fault may be a fault attributable to the analysis target application or may be a fault attributable to another application. So, which fault event from among many fault events should be checked cannot be recognized, which results in the problem that it takes time until the fault is dealt with.

Furthermore, since a fault event of an application does not have information like the performance history, a simple correlation analysis cannot be applied and it is necessary to extract related fault events in accordance with a maintenance manual which is designed in advance, which results in the problem that it takes time until the fault is dealt with.

The present invention was devised in consideration of the above-described circumstances and aims at proposing a management system with high maintainability capable of promptly achieving fault recovery.

### Means to Solve the Problems

In order to solve the above-described problems, provided according to the present invention is a management system for managing a plurality of applications, wherein the management system includes: a storage unit that stores event information of events, which have occurred in each of the plurality of applications, and related information indicative of a relation between applications with respect to the plurality of applications; an input unit that inputs information of an application which is an analysis origin from among the plurality of applications; an identification unit that identifies applications related to the application, which is the analysis origin, based on the related information stored in the storage unit; and an extraction unit that extracts the event information of the application, which is the analysis origin, and the event information of the related applications from the event information stored in the storage unit.

Furthermore, provided according to the present invention is a management apparatus for managing a plurality of applications, wherein the management apparatus includes: a storage unit that stores event information of events, which have occurred in each of the plurality of applications, and related information indicative of a relation between applications with respect to the plurality of applications; an input unit that inputs information of an application which is an analysis origin from among the plurality of applications; an identification unit that identifies applications related to the application, which is the analysis origin, based on the related information stored in the storage unit; and an extraction unit that extracts the event information of the application, which is the analysis origin, and the event information of the related applications from the event information stored in the storage unit.

Furthermore, provided according to the present invention is a management method for a management apparatus including a storage unit that stores event information of events, which have occurred in each of a plurality of applications, and related information indicative of a relation between applications with respect to the plurality of applications, wherein the management method includes: a first step executed by an input unit inputting information of an application which is an analysis origin from among the plurality of applications; a second step executed by an identification unit identifying applications related to the application, which is the analysis origin, based on the related information stored in the storage unit; and a third step executed by an extraction unit extracting the event information of the application, which is the analysis origin, and the event information of the related applications from the event information stored in the storage unit.

According to the present invention, applications related to the application which is the analysis origin can be narrowed down and the event information of the analysis origin application and the related applications can be narrowed down, so that the range of influences and factors of the relevant event such as a fault can be easily recognized and the fault recovery can be dealt with promptly.

### Advantageous Effects of the Invention

The management system with high maintainability capable of promptly achieving the fault recovery can be implemented according to the present invention.

### BRIEF DESCRIPTION OF DRAWINGS

FIG. 1 is a diagram illustrating a schematic configuration of a management system and a computer system according to an embodiment;

FIG. 2 is a diagram illustrating a configuration information table according to the embodiment;

FIG. 3 is a diagram illustrating a performance information table according to the embodiment;

FIG. 4 is a diagram illustrating an event information table according to the embodiment;

FIG. 5 is a diagram illustrating a related information table according to the embodiment;

FIG. 6 is a diagram illustrating a relevance information table according to the embodiment;

FIG. 7 is a diagram illustrating a connection configuration of a computer network for the computer system according to the embodiment;

FIG. 8 is a diagram illustrating preprocessing according to the embodiment;

FIG. 9 is a flowchart illustrating analysis target extraction processing and display processing according to the embodiment;

FIG. 10 is a diagram illustrating the relation between applications according to the embodiment; and

FIG. 11 is a diagram illustrating a display screen according to the embodiment.

### DESCRIPTION OF EMBODIMENTS

An embodiment of the present invention will be described below in detail with reference to the drawings.

### (1) First Embodiment

(Management System)

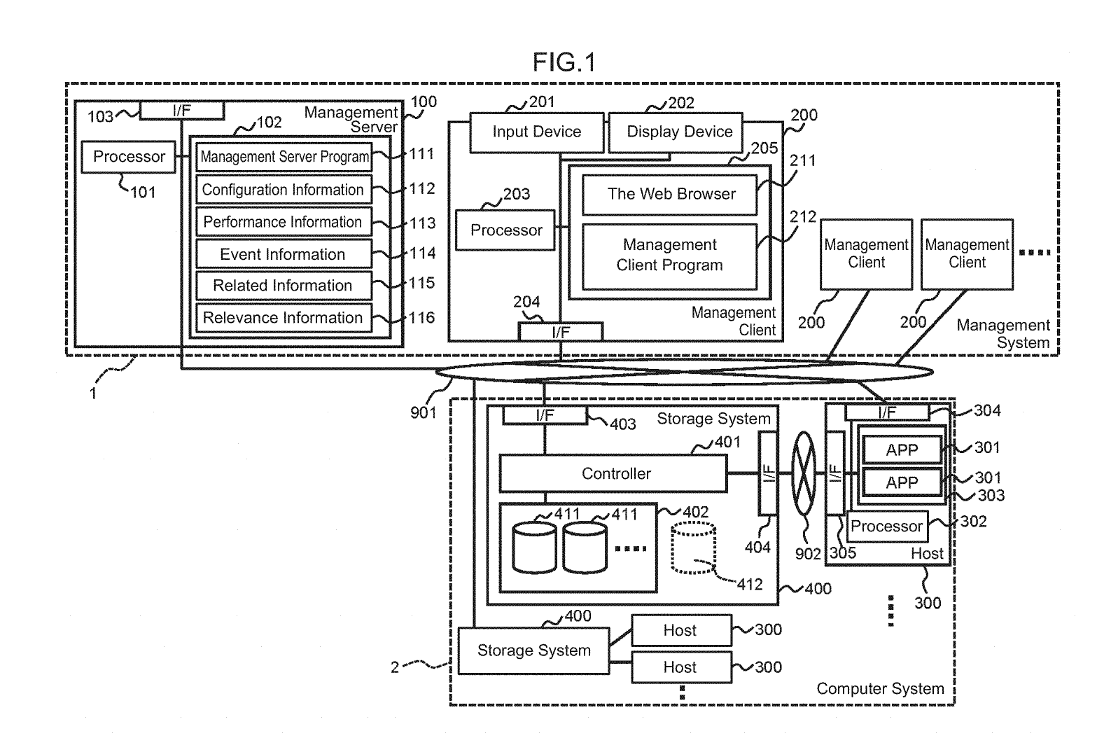

Referring to FIG. 1, 1 represents a management system as a whole according to a first embodiment. This management system 1 includes a management server 100 and one or more management clients 200 connected to the management server 100. The management server 100 and the management client(s) 200 are connected via a communication network 901 (such as a LAN [Local Area Network], a WAN [World Area Network], or the Internet).

With this management system 1, event information 114 which has occurred in an application that is an analysis origin set by a user, and applications related to the relevant application is extracted by the management server 100 from the event information 114 collected by a computer system 2 described later and is then displayed by the management client 200. When this management system 1 is used, the event information 114 related to the analysis origin application can be appropriately narrowed down from among many pieces of the event information 114, so that the time it takes until a fault is dealt with can be reduced. The detailed explanation will be given below.

(Management Server [Management Apparatus])

The management server 100 includes: a processor 101 (such as a CPU [Central Processing Unit]) for executing various processing; a storage resource 102 (such as a RAM [Random Access Memory], a ROM [Read Only Memory], and an HDD [Hard Disk Drive]) for storing various kinds of information; and an I/F (interface) 103 for communicating with the outside.

As the processor 101 executes a management server program 111 stored in the storage resource 102, various functions of the management server 100 are implemented. For example, by executing the management server program 111, the processor 101 receives instructions according to the user's operation from the management client 200, generates information to be drawn in a layout area (screen information), and transmits it to the management client 200. Under this circumstance, the management server program 111 may be stored in a storage medium (such as a Compact Disc, a Digital Versatile Disc, or a Magneto-Optical disk) and then stored from the storage medium into the storage resource 102 or may be stored in another information processing unit and then downloaded from that other information processing unit and stored in the storage resource 102.

The storage resource 102 stores computer programs to be executed by the processor 101 and information to be used by the processor 101. The storage resource 102 stores, for example, the management server program 111, configuration information 112, performance information 113, event information 114, related information 115, and relevance information 116. Some of the information stored in the storage resource 102 may be directly acquired (or collected) from a host 300 by the management server program 111 or may be acquired by accessing another information processing unit which retains (or manages) information of the host 300.

The I/F 103 is connected to the communication network 901 and the management server 100 communicates with the outside (such as the management client 200, the host 300, and a management server [not shown in the drawing] that manages information of the host 300) via the I/F 103. The management server 100 receives instructions according to the user's operation and transmits the screen information via the I/F 103. Incidentally, the I/F 103 is an example of an I/O (Input/Output) interface device.

(Management Client)

The management client 200 includes: an input device 201 that performs various kinds of inputs; a display device 202 that performs various kinds of displays; a processor 203 that executes various processing; an I/F 204 that communicates with the outside; and a storage resource 205 that stores various kinds of information. The input device 201 is, for example, a pointing device and a keyboard. The display device 202 is a display such as a liquid crystal display device with a physical screen on which information is to be displayed. Incidentally, a touch screen in which the input device 201 and the display device 202 are integrated may be used.

The processor 203 is, for example, a CPU and executes a web browser 211 and a management client program 212 which are stored in the storage resource 205, thereby implementing various kinds of functions of the management client 200. For example, by executing the web browser 211 and the management client program 212, the processor 203 transmits instructions according to the user's operation to the management server 100 and receives the screen information from the management server 100. The I/F 204 is connected to the communication network 901 and the management client 200 communicates with the management server 100 via the I/F 204.

The storage resource 205 is, for example, a RAM, a ROM, and an HDD and stores computer programs to be executed by the processor 203 and information to be used by the processor 203. For example, the storage resource 205 stores the web browser 211 and the management client program 212. The management client program 212 may be an RIA (Rich Internet Application) or may not be the RIA. The management client program 212 is stored in a storage medium (such as a Compact Disc, a Digital Versatile Disc, or a Magneto-Optical disk) and then stores from the storage medium to the storage resource 205 or may be stored in another information processing unit and then downloaded from that other information processing unit and stored in the storage resource 205.

In this embodiment, a GUI screen display which accepts the user's operation is implemented by cooperation between the management server program 111, the web browser 211, and the management client program 212. For example, the management server program 111 receives an instruction according to the user's operation with respect to a display screen from the web browser 211 or the management client program 212 (such as the web browser 211), creates display information (for example, the screen information) based on the instruction and the information stored in the storage resource 102, and transmits the display information to, for example, the web browser 211. The web browser 211 or the like receives the display information and displays a screen in accordance with the display information.

(Computer System)

The computer system 2 includes one or more hosts 300 and one or more storage systems 400 connected to the one or more hosts 300. The hosts 300 and the storage systems 400 are connected via a communication network 902 (such as a SAN [Storage Area Network] or a LAN) so that they can communicate with each other. Incidentally, a part or whole of the communication network 901 and the communication network 902 may be in common with each other.

(Host [Physical Computer or Virtual Computer])

The host 300 includes one or more application programs (APP 301). The host 300 may be a physical computer (physical machine) or a virtual computer (virtual machine). For example, the host 300 includes: a processor 302, a storage resource 303, and an I/F 303 capable of communicating with the outside (such as the management server 100 and other hosts 300) via the communication network 901, and an I/F 304 capable of communicating with the outside (such as other hosts 300 and the storage system 400) via the communication network 902. Additionally, the APP 301 may operate on a physical machine or may operate on a virtual machine. As a result of execution of the APP 301 at the host 300, for example, an I/O command designating a logical volume is transmitted from the host 300 to the storage system 400.

(Storage System)

The storage system 400 includes a controller 401, a physical storage device group 402, an I/F 403, and an I/F 404.

The controller 401 includes a port, an MPB (a blade [a circuit board] having one or more microprocessors (MP)), a cache memory, and so on. For example, the port receives an I/O command (write command or read command) from the host 300 and the MP controls input/output of data in accordance with the relevant I/O command.

The physical storage device group 402 includes one or more PGs (Parity Groups). The PGs are sometimes called a RAID (Redundant Array of Independent [or Inexpensive] Disks) group. A PG is composed of a plurality of physical storage devices and store data according to a specified RAID level. The physical storage devices are HDDs, SSDs (Solid State Drives), and so on. Furthermore, the storage system 400 includes a plurality of logical volumes. The logical volume(s) may be a substantive logical volume(s) (real volume(s)) 411 based on a PG(s) or may be a virtual logical volume (virtual volume(s)) 412 in accordance with, for example, thin provisioning or storage virtualization technology.

(Tables that Store Various Kinds of Information in Management System)

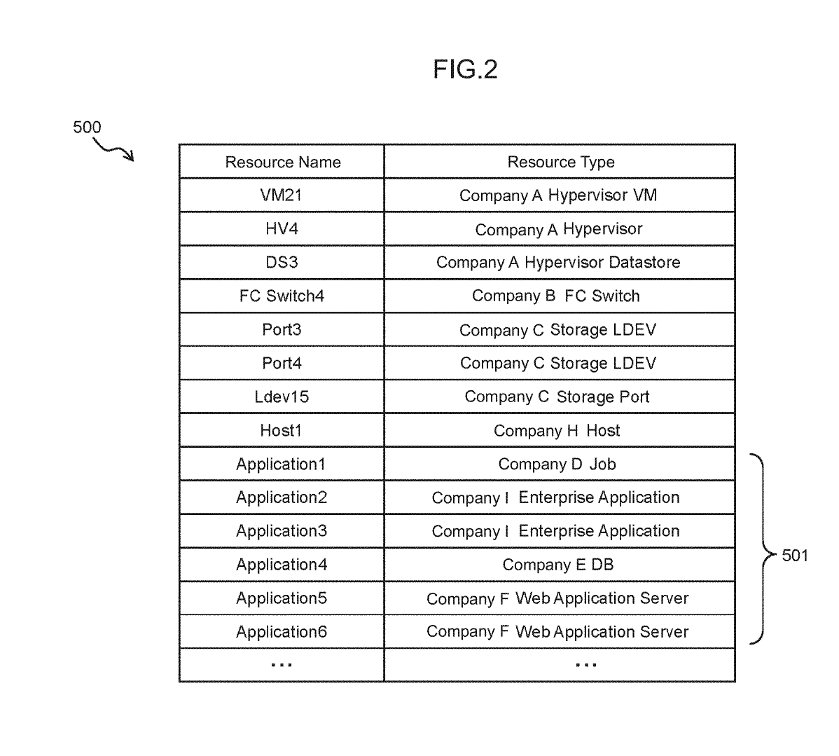

Tables that store various kinds of information in the management system 1 will be explained with reference to FIG. 2 to FIG. 6. FIG. 2 illustrates an example of a configuration information table 500 that stores the configuration information 112. The configuration information table 500 stores information about the configuration of the computer system 2. More specifically, the configuration information table 500 stores information of resource names and resource types. For example, the configuration information table 500 stores the resource names and the resource types of applications as indicated in rows 501 in addition to the resource names and the resource types of hardware and logical elements (virtual machines, hypervisors, data stores, etc.). In this embodiment, various types of software such as job management software, application software, transaction processing software, application server software, DB (database) software, and OS (Operating System) are referred to as the “applications.”

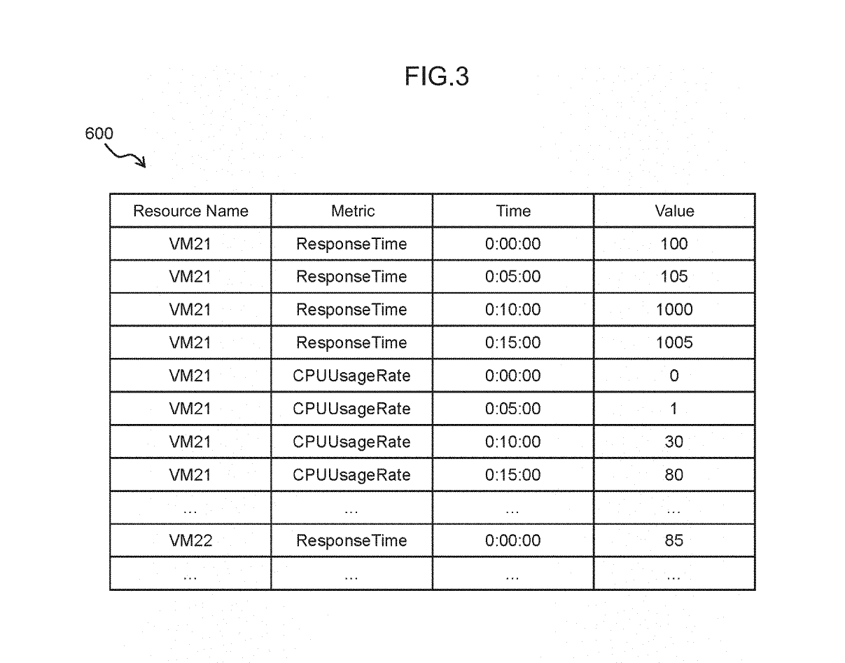

FIG. 3 illustrates an example of a performance information table 600 that stores the performance information 113. The performance information table 600 stores information about the performance of infrastructures such as physical machines and virtual machines (VMs). More specifically, the performance information table 600 stores information of resource names, metrics, time, and values.

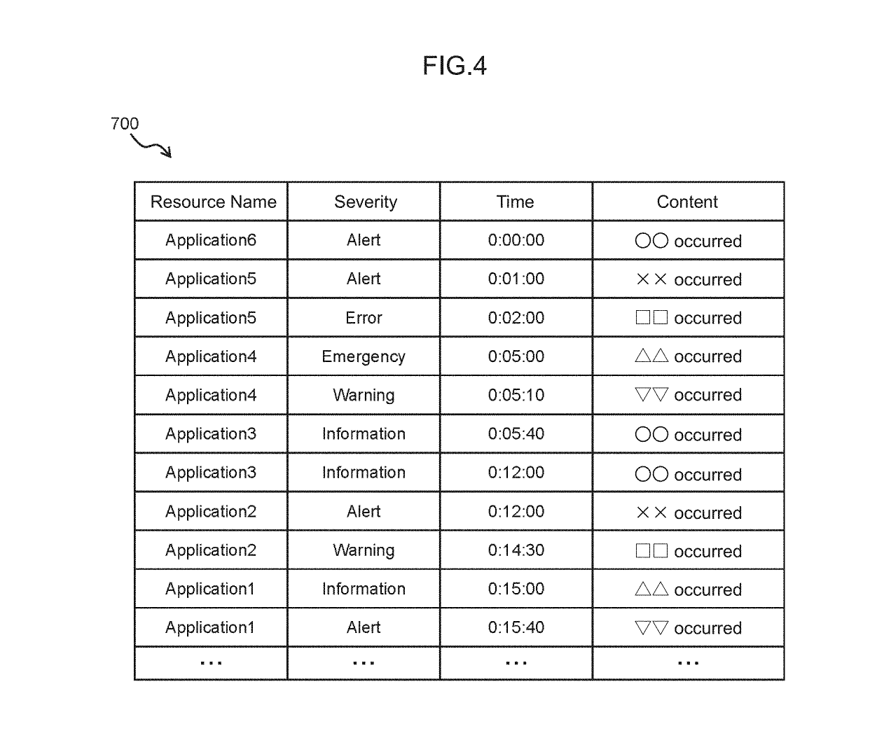

FIG. 4 illustrates an example of an event information table 700 that stores the event information 114. The event information table 700 stores information about events which have occurred in resources such as applications. More specifically, the event information table 700 stores information of resource names, severity, time, and content. A plurality of degrees (levels) are provided as the severity. In this embodiment, Emergency, Alert, Critical, Error, Warning, Notice, Information, and Debug are provided in descending order of the severity. Incidentally, the severity is not limited to eight levels and may be less than eight levels or more than eight levels.

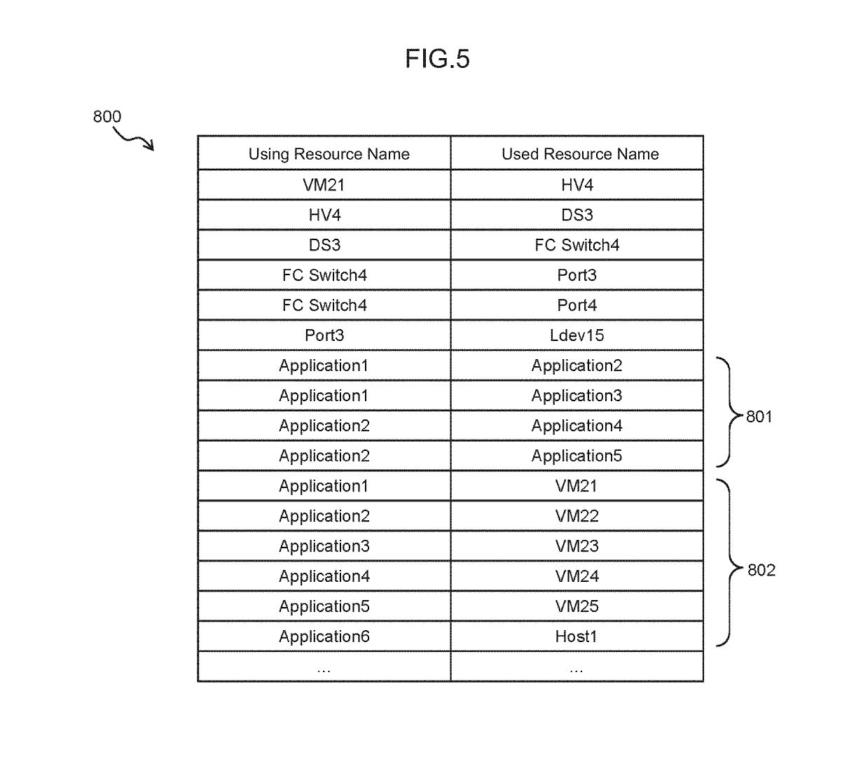

FIG. 5 illustrates an example of a related information table 800 that stores the related information 115. The related information table 800 stores information about the relation between using resources and used resources. More specifically, the related information table 800 stores information of using resource names and used resource names. For example, in addition to the using resource names and the used resource names of combinations between pieces of hardware, between logical elements (virtual machines, hypervisors, data stores, etc.), and between hardware and logical elements, the related information table 800 stores the using resource names and the used resource names of combinations between applications as indicated in rows 801 and stores the using resource names and the used resource names of combinations between applications and infrastructures (such as physical machines [such as “Host1”) or virtual machines [such as “VM21”]) as indicated in rows 802.

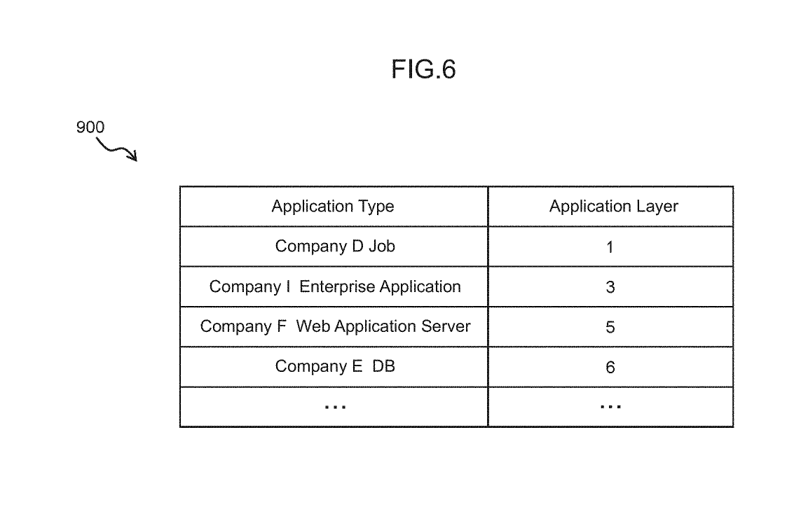

FIG. 6 illustrates an example of a relevance information table 900 that stores the relevance information 116. The relevance information table 900 stores information about the relevance between applications. More specifically, the relevance information table 900 stores information of application types and application layers. In this embodiment, a first layer “Job,” a second layer “Service Response,” a third layer “Enterprise,” a fourth layer “Transaction Processing,” a fifth layer “Application Server,” a sixth layer “Database,” and a seventh layer “Platform” are provided and applications are automatically or manually classified into any one of the layers. Incidentally, the application layers are not limited to seven layers and may be less than seven layers or more than seven layers. A plurality of layers are provided as the application layers.

Basically, when the layers between the applications are closer to each other (that is, when the layer difference is smaller), it means that the relevance between the applications is higher. However, regarding the same layer difference for one application (nth layer application), an application having a high relevance to it (an (n−1)th layer application or an (n+1)th layer application) is defined in advance.

(Topology Configuration Example of Management Target Computer System)

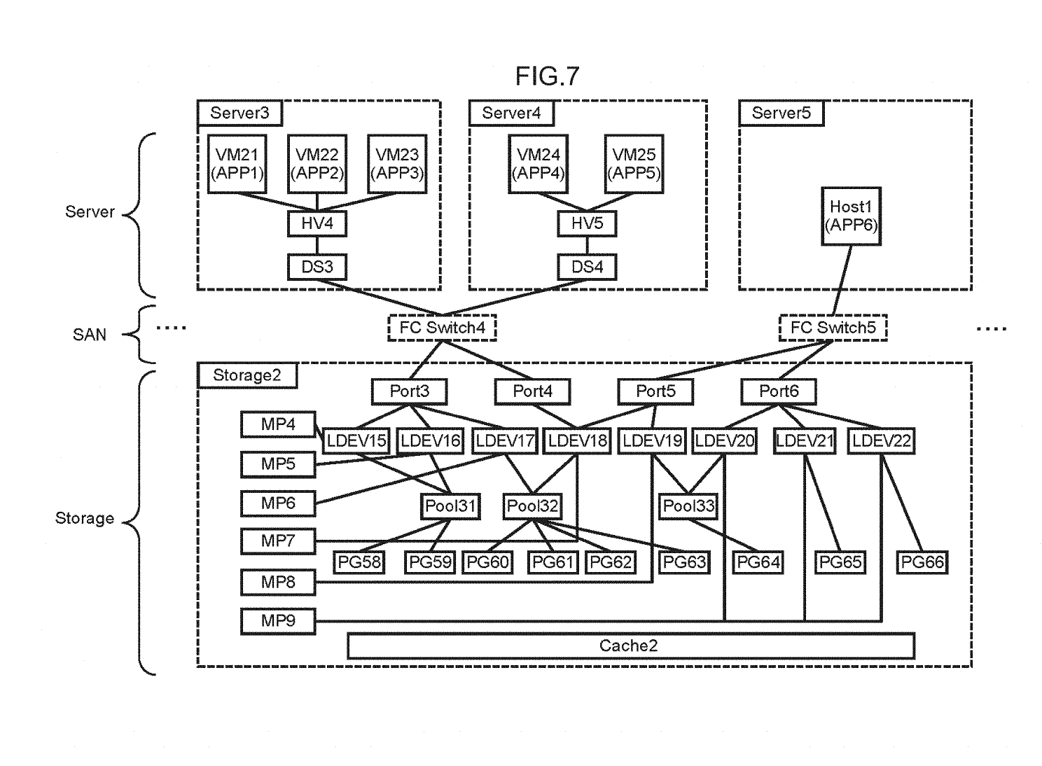

FIG. 7 illustrates an example of a connection configuration (topology configuration) of a computer network for a computer system 2 which is a management target. The topology configuration of the management target computer system 2 can be created based on the configuration information 112 and the related information 115.

There are a plurality of layers that are, for example, Server, SAN, and Storage in descending order starting from a higher layer. Element types belonging to a first layer (highest layer) “Server” are “VM,” “HV,” “DS,” and “Host.” An element(s) belonging to the element type “VM” is a “VM” (a virtual machine executed by the host 300). An element(s) belonging to the element type “HV” is an “HV” (a hypervisor which controls one or more virtual machines and is executed by the host 300). An element(s) belonging to the element type “DS” is a “DS” (data store). The data store is an element recognized as a storage device by the hypervisor. An element(s) belonging to the element type “Host” is a “Host” (host 300).

An element type belonging to the second layer “SAN” is an “FC-SW”; and an element belonging to the element type “FC-SW” is an “FC-SW” (an FC [Fibre Channel] switch in a SAN).

An element type belonging to the third layer “Storage” is “Storage” and an element belonging to the element type “Storage” is “Storage.” Element types included in the element type “Storage” are a plurality of element types in Storage, for example, “Port,” “LDEV,” “MP,” “Pool,” “PG,” and “Cache.” An element(s) belonging to the element type “Port” is a “Port” (a communication port that is connected to an FC switch and receives an I/O command from a virtual machine). An element(s) belonging to the element type “LDEV” is an “LDEV” (a logical volume [real volume or virtual volume]). An element(s) belonging to the element type “MP” is an “MP” (a microprocessor). An element(s) belonging to the element type “Pool” is a “Pool” (a storage area including a real area allocated to a virtual volume in accordance with thin provisioning). An element(s) belonging to the element type “PG” is a “PG” (a parity group). An element(s) belonging to the element type “Cache” is a “Cache” (a cache memory in which data that is input to, or output from, a logical volume(s) is temporarily stored).

The topology configuration illustrated in FIG. 7 is an example and one or more element types may belong to one layer. Furthermore, two or more elements of the same element type may constitute one group; and in that case, a plurality of different groups may exist with respect to one element type and one or more elements of that element type may exist for each group. In other words, a “layer” is an aggregate of different element types and a “group” is an aggregate of different elements of the same element type. At least either the layer(s) or the group(s) may be defined by the user.

(Preprocessing Relating to Extraction and Displaying of Analysis Target in Management System)

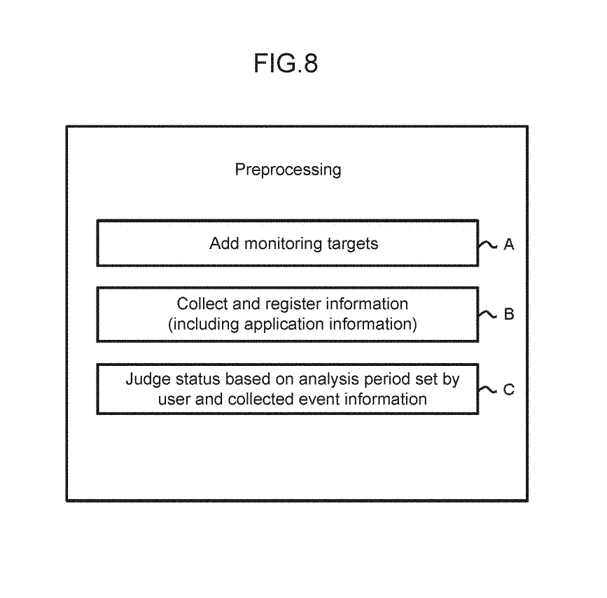

FIG. 8 illustrates an example of preprocessing relating to extraction and displaying of an analysis target in the management system 1.

Regarding preprocessing A, a monitoring target(s) is set (monitoring equipment, monitoring applications, etc. are added) by the user via the management client 200. When this happens, the monitoring targets may be set individually or another management server for managing the monitoring targets may be set.

Regarding preprocessing B, the management server 100 regularly collects and register the configuration information 112, the performance information 113, the event information 114, and the related information 115 of the set monitoring target(s) from the host 300 and other information processing units and the like which retain information of the host 300, at predetermining timing or in accordance with the user's instruction. Incidentally, the relevance information 116 is automatically or manually updated based on the collected information.

When a certain application invokes another application during batch processing or the like under this circumstance and the management server 100 cannot recognize such a relation, the relation between applications is defined by the user regarding such a case (the case where the information cannot be collected automatically) and is thereby registered as the related information 115. Furthermore, regarding a case where the management server 100 cannot recognize the relation between an application and an infrastructure, the relation between the application and the infrastructure is defined by the user and is thereby registered as the related information 115.

Regarding preprocessing C, the management server 100 receives a period of time which is an analysis target (an analysis period) from the user, judges the status of the event information collected based on the received analysis period, and displays the status (information capable of identifying the status, for example, words, signs, and pictures) of each application on the management client 200. Under this circumstance, a plurality of sections are provided as the status. In this embodiment, the severity of the event information is divided into three sections: the severity of “Error” or higher is judged to be a first status; the severity of “Warning” is judged to be a second status; and the severity of “Notice” or lower is judged to be a third status. Incidentally, the sections of the status are not limited to three sections, but the number of sections may be less than three or more than three or may be the same number as that of the levels of the severity. Accordingly, the user can easily select an application which should be the analysis origin, by displaying the status to which the highest severity belongs during the analysis period with respect to each application.

(Analysis Target Extraction Processing and Display Processing by Management System)

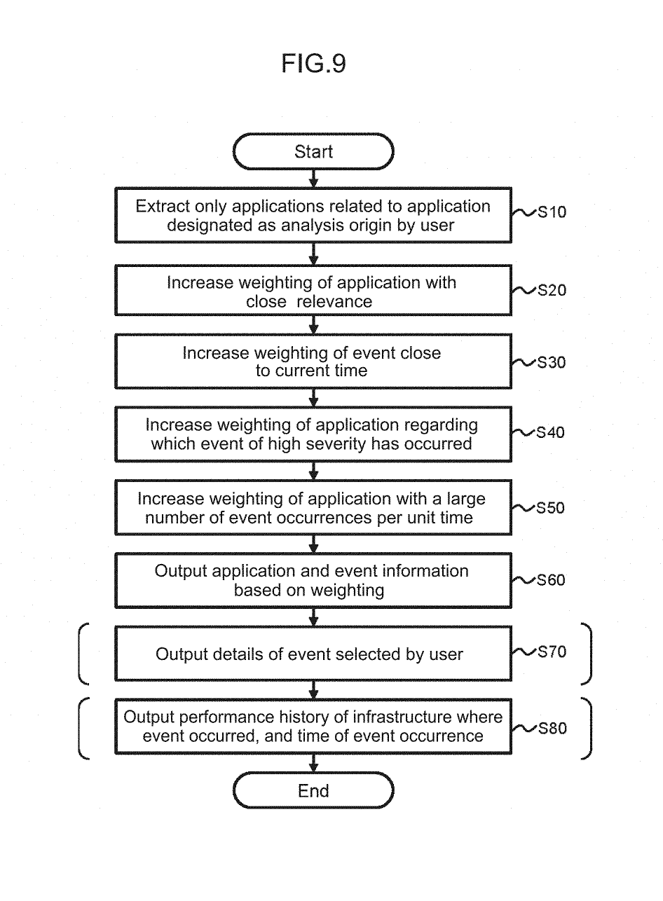

FIG. 9 illustrates an example of a processing sequence for analysis target extraction processing and display processing by the management system 1.

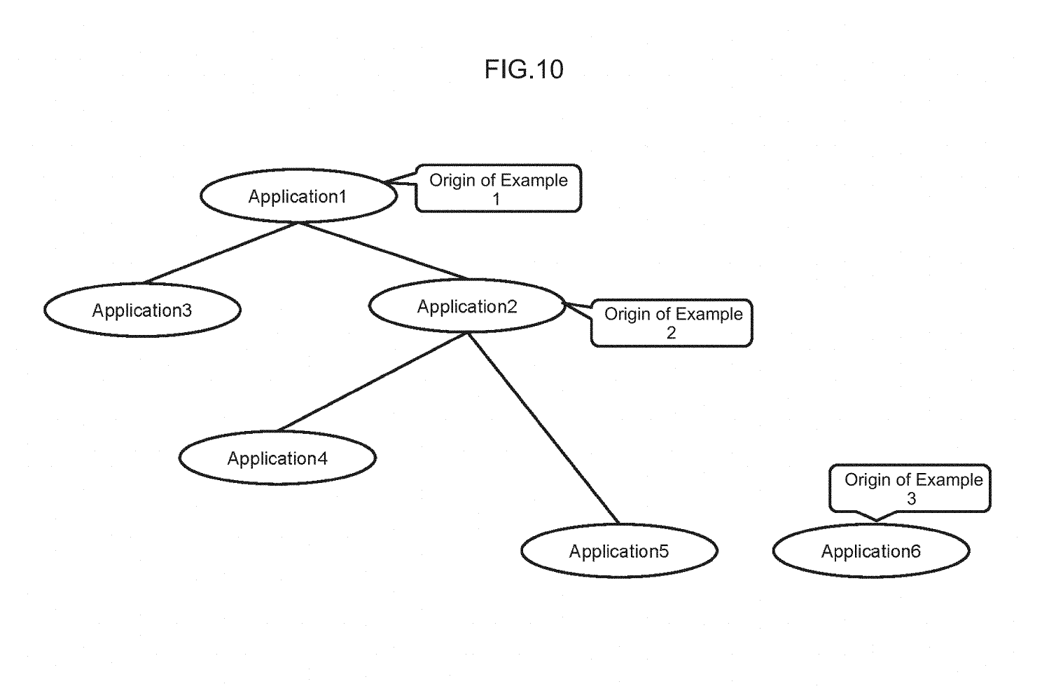

Firstly, the management server 100 extracts the application designated as the analysis origin by the user and the applications related to that application on the basis of the configuration information 112 and the related information 115 (step S10). For example, when the related information 115 illustrated in the related information table 800 is stored, the relation between applications is identified as illustrated in FIG. 10.

### EXAMPLE 1

### When “Application 1” is Designated as Analysis Origin

It is identified based on the related information 115 that “Application 2” and “Application 3” which are used resources of “Application 1” are related to “Application 1.” Furthermore, it is identified that “Application 4” and “Application 5” which are used resources of “Application 2” are also related to “Application 1.” Therefore, when “Application 1” is designated as the analysis origin, “Application 1,” “Application 2,” “Application 3,” “Application 4,” and “Application 5” are extracted.

### EXAMPLE 2

### When “Application 2” Is Designated as Analysis Origin

It is identified based on the related information 115 that “Application 4” and “Application 5” which are the used resources of “Application 2” are related to “Application 2.” Furthermore, it is identified that “Application 1” which is a using resource of “Application 2” is also related to “Application 2.” Incidentally, if there is a using resource of “Application 1,” it is identified by tracking back using resources that the above-mentioned using resource (application) is also related; however, it is not identified that the used resources of “Application 1” are related. Specifically speaking, after tracking back the used resources, the using resources will not be tracked back. Furthermore, after tracking back the using resources, the used resources will not be tracked back. Therefore, when “Application 2” is designated as the analysis origin, “Application 1,” “Application 2,” “Application 4,” and “Application 5” are extracted.

### EXAMPLE 3

### When “Application 6” Is Designated as Analysis Origin

Since it is identified based on the related information 115 that there are no using resource or used resource with respect to “Application 6,” only “Application 6” is extracted.

Accordingly, the analysis range (for example, the range of influences caused by a fault) can be recognized easily by extracting an application(s) related to the analysis origin application.

Subsequently, the management server 100 increases weighting of an application with close relevance (step S20). More specifically, the management server 100 calculates the layer difference with respect to the application(s) extracted in step S10 on the basis of the configuration information 112 and the relevance information 116 and calculates a relevance score. For example, when “Application 1” is designated as the analysis origin, the layer difference between “Application 1” and “Application 2” is “2” because the layer of “Application 1” is “1” and the layer of “Application 2” is “3.” Furthermore, for example, the layer difference between “Application 1” and “Application 5” is “4” because the layer of “Application 1” is “1” and the layer of “Application 5” is “5.”

In this embodiment, the management server 100 recognizes the application which is the analysis origin has the highest relevance, sets its score as “1,” and sets a higher score to an application with a larger layer difference. Incidentally, in a case of the same layer difference, the same score is set for the layer difference between the same layers and a predefined different score is set for the layer difference between different layers.

Accordingly, by applying the weighting of the relevance, the user can proceed with the analysis by starting from applications with close relevance, so that factors of the relevant fault or the like can be analyzed efficiently.

Subsequently, the management server 100 increases the weighting of an event close to the current time (step S30). More specifically, the management server 100 sets a higher occurrence time score to the event information 114 regarding which the time of the event information 114 (for example, occurrence time of an event) is farther away from the current time, with respect to the event information 114 of the application(s) extracted in step S10. Incidentally, when the time is the same, the same score is set.

Accordingly, by applying the weighting of the occurrence time, the user can recognize the event information in chronological order, so that factors of the relevant fault or the like can be analyzed efficiently.

Subsequently, the management server 100 increases the weighting of an application regarding which an event of high severity has occurred (step S40). More specifically, the management server 100 calculates a severity score used to display the application and a severity score used to display the event on the basis of the event information 114 of the application(s) extracted in step S10.

The management server 100 identifies the highest severity of the event information 114 for each application, sets a higher score for an application regarding which the identified severity is lower, and calculates the severity score used to display the application. For example, the severity of “Application 1” is “Information” and “Alert,” so that “Alert” is identified as the highest severity. Incidentally, the management server 100 does not display an application regarding which the calculated score is equal to or more than a threshold value (an application of low severity).

Accordingly, by applying the weighting of the severity, the user can proceed with the analysis by starting from applications of high severity, so that factors of the relevant fault or the like can be analyzed efficiently. Furthermore, the user can narrow down the analysis range by not displaying applications of low severity.

Furthermore, the management server 100 identifies the highest severity of the event information 114 for each application and at each specified time interval, sets a higher score for an application regarding which the identified severity is lower, and calculates the severity score used to display an event. For example, the management server 100 does not display an event regarding which the calculated score is equal to or more than a threshold value (an event of low severity). Under this circumstance, any value may be set as the specified time interval; however, because of limitations of a screen display, a value obtained by equally dividing the analysis period designated by the user (for example, into 6 or 7 equally divided time intervals) should preferably be used.

Accordingly, by applying the weighting of the severity, the user can recognize the event information of high severity, so that factors of the relevant fault or the like can be analyzed efficiently. Furthermore, the user can narrow down the analysis range by not displaying the event information of low severity.

Subsequently, the management server 100 increases the weighting of an application regarding which the number of event occurrences per the unit time is large (step S50). More specifically, the management server 100 calculates a number-of-occurrences score used to display the application and a number-of-occurrences score used to display the event on the basis of the event information 114 of the application(s) extracted in step S10.

The management server 100 counts the number of event occurrences for each application (the number of pieces of the event information 114), sets a higher score to an application regarding which the number of event occurrences is smaller, and calculates the number-of-occurrences score used to display the application.

Accordingly, by applying the weighting of the number of occurrences, the user can proceed with the analysis by starting from applications regarding which the number of occurrences is large, so that factors of the relevant fault or the like can be analyzed efficiently.

Furthermore, the management server 100 counts the number of event occurrences for each event display (for each application and at each specified time interval), sets a higher score to a display target regarding which the number of event occurrences is smaller, and calculates the number-of-occurrences score used to display the event.

Accordingly, by applying the weighting of the number of occurrences, the user can recognize the event display regarding which the number of occurrences is large, so that factors of the relevant fault or the like can be analyzed efficiently.

Subsequently, the management server 100 outputs application and event information on the basis of the scores calculated in step S20 to step S50 (step S60). In this embodiment, displays are taken as an example of the output for explanation; however, the output is not limited to this example. For example, the information may be output as files (data), printed on a medium such as paper, output as sounds, or output in any other forms.

(Determination of Sequential Order to Display Applications)

The management server 100 determines the sequential order to display applications based on the relevance score, the severity score, and the number-of-occurrences score. More specifically, the management server 100 determines the sequential order to display applications by: sorting the applications extracted in step S10 in the order of the relevance score; further sorting them in the order of the severity score if there are applications with the same relevance score; and further sorting them in the order of the number-of-occurrences score if there are applications with the same severity score.

In the above-described example, the scores are prioritized in the order of the relevance score, the severity score, and the number-of-occurrences score; however, they may be prioritized in other manners. Furthermore, in the above-described example, the applications are sorted by using all the scores of the relevance score, the severity score, and the number-of-occurrences score; however, not all the scores may have to be used and some of the scores may be used. Furthermore, regarding settings of the respective priorities and settings of the respective scores to be used, they may be defined in advance or may be changed (customized) by the user.

(Determination of Display Event)

Furthermore, the management server 100 determines a display event based on the occurrence time score, the severity score, and the number-of-occurrences score. More specifically, the management server 100: identifies an event of the highest severity based on the severity score for each application and for each display section (specified time interval); further identifies an event which has occurred at closest time based on the occurrence time score if there are events of the same severity; further identifies an event based on the number-of-occurrences score if there are events of the same occurrence time score; and determines information of the identified event information (such as the event information 114) as the display event.

In the above-described example, the scores are prioritized in the order of the severity score, the occurrence time score, the number-of-occurrences score; however, they may be prioritized in other manners. Furthermore, in the above-described example, the event to be displayed is identified by using all the scores of the occurrence time score, the severity score, the number-of-occurrences score; however, not all the scores may have to be used and some of the scores may be used. Furthermore, regarding settings of the respective priorities and settings of the respective scores to be used, they may be defined in advance or may be changed (customized) by the user.

(Displaying of Information about Applications and Information about Events)

The management server 100: generates the screen information to display information about applications (for example, the resource names) in the determined display sequential order and to display information about events (for example, information indicative of the severity of the identified events) by associating such information with the applications and the display sections; and then displays the screen information on the management client 200.

More specifically, the management server 100 displays an application with higher relevance (with a lower score), from among the applications related to the analysis origin application, at a position closer to the analysis origin application. When this happens and if there are applications with the same relevance, the management server 100 displays an application with higher severity (with a lower score) at a position closer to the analysis origin application. Furthermore, if there are applications with the same severity, the management server 100 displays an application with a larger number of occurrences (with a lower score) at a position closer to the analysis origin application. Furthermore, the management server 100 does not display information about an application regarding which the severity score is equal to or more than a threshold value (for example, a score corresponding to “Information” and “Debug”), from among the related applications. Incidentally, the threshold value may be set in advance or may be set (customized) by the user.

Furthermore, the management server 100 collects and displays information about events for each application and for each display section. Regarding the collective display, the management server 100 displays information indicative of the severity of the identified event and displays the number of event occurrences. However, the management server 100 does not display information about an event regarding which the severity score of the identified event is equal to or more than a threshold value (for example, a score corresponding to “Information” and “Debug”). If such a configuration is employed, an event for which a fault needs to be dealt with can be recognized promptly. Incidentally, the threshold value may be set in advance or may be set (customized) by the user.

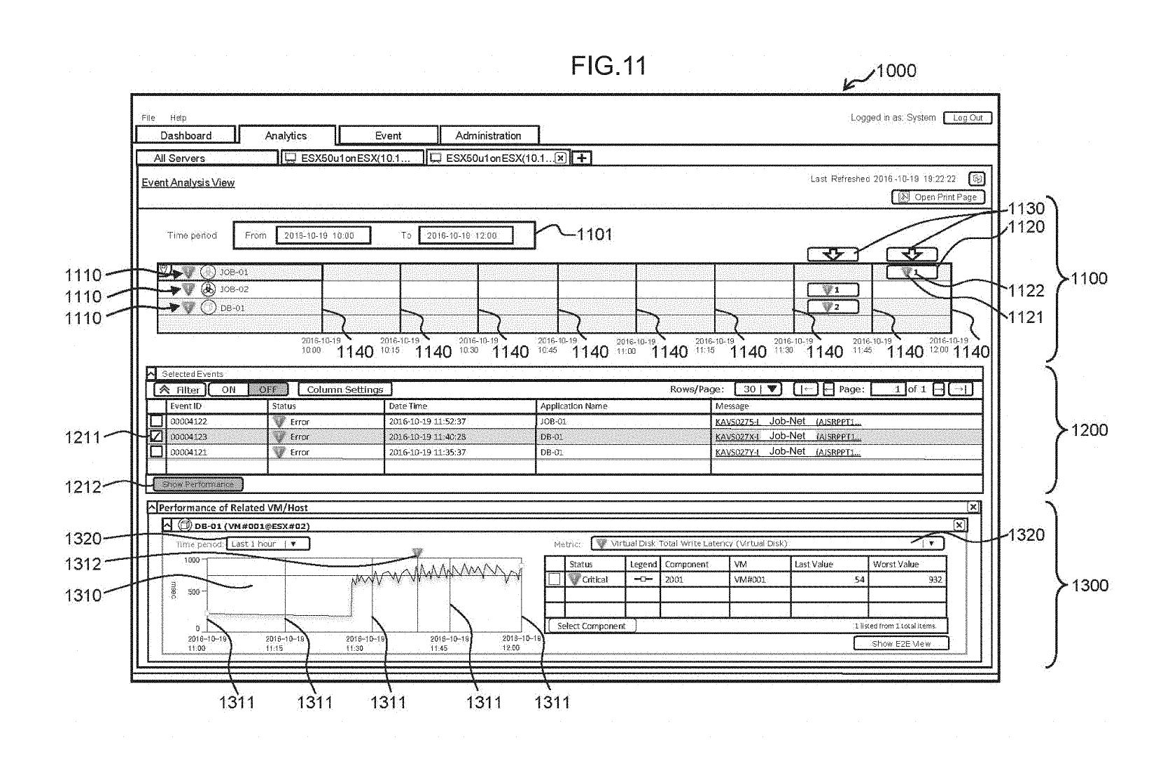

FIG. 11 illustrates a display example (a display screen 1000) of the information about applications and the information about events. The display screen 1000 is generated by the management server 100 and is displayed on the management client 200. An event-related display area 1100 capable of displaying the information about events for each application is displayed on the display screen 1000. Furthermore, when the information about an event is selected in the event-related display area 1100, an event information display area 1200 capable of displaying the details of the information about the selected event (the event information 114) is displayed on the display screen 1000. Furthermore, when the event information 114 is selected in the event information display area 1200, a performance information display area 1300 capable of displaying the performance information 113 of an infrastructure (physical machine or virtual machine) relating to the event information 114 selected in the event information display area 1200 is displayed on the display screen 1000.

(Event-Related Display Area)

Time period information 1101 indicative of the analysis period and application information 1110 of applications related to the analysis origin (such as an icon indicative of the highest severity of the application, an icon indicative of the application type, and the resource name) are displayed in the event-related display area 1100. The content of the application information 1110 is not limited to the above-described content and a display name of the relevant application (such as an application name) may be stored in the storage resource 102 with respect to each application, the display name may be displayed instead of the resource name, and other information may be displayed.

Regarding the application information 1110, the application information 1110 of the analysis origin application is displayed at the highest position; and the application information 1110 of an application with higher relevance is displayed at a higher position, the application information 1110 of an application with higher severity is displayed at a higher position, and the application information 1110 of an application with a larger number of occurrences is displayed at a higher position on the basis of the score relating to the relevance, the score relating to the severity, and the score relating to the number of occurrences.

Furthermore, the event-related display area 1100 is divided into sections at every specified time interval and the event information 114 is mapped to each time interval and is displayed as one event icon 1120. The event icon 1120 is provided in such a manner that severity information 1121 indicative of the highest severity with respect to an event(s) during the relevant time interval and number-of-occurrences information 1122 indicative of the number of event occurrences for the relevant time interval can be recognized.

Furthermore, a select button 1130 is provided for each time interval, to which the event information 114 is mapped, in the event-related display area 1100. All pieces of the event information 114 (all event icons 1120) which are mapped to the time interval corresponding to the relevant select button are selected by pressing the select button 1130. Furthermore, a time interval line 1140 is provided for each specified time interval in the event-related display area 1100.

When such an event-related display area 1100 is used, an application which has higher relevance to the analysis origin application and regarding which many severe events have occurred is displayed at a position closer to the analysis origin application and the event icon 1120 capable of recognizing the severity of events and the number of occurrences of events for each specified time interval is displayed, so that the range of influences of the analysis origin application and the priorities to deal with the fault can be easily recognized.

(Event Information Display Area)

The management server 100 outputs the details of the information about the event selected by the user (step S70). For example, when the event icon 1120 is selected in the event-related display area 1100 according to the user's operation, the management server 100 generates the screen information to display the event information display area 1200 capable of displaying the details of the selected event icon 1120 (for example, the event information 114) on the display screen 1000.

More specifically, the event information 114 of the event icon 1120 selected in the event-related display area 1100 is displayed in a list format in the event information display area 1200. When there are a plurality of pieces of event information 114, the event information 114 of higher severity is displayed at a higher position and the event information 114 closer to the current time is displayed at a higher position.

FIG. 11 shows “Event ID,” “Status (Severity),” “Date Time (Time),” “Application Name (Resource Name),” and “Message (Content)” as examples of items displayed in the event information 114; however, the items are not limited to these examples and any appropriate items can be displayed.

Regarding an initial display, the event information 114 of higher severity is displayed at a higher position; and regarding the event information 114 of the same severity, the event information 114 closer to the current time is displayed at a higher position. Accordingly, the user can promptly recognize the event information 114 of the event for which it is required to deal with a fault. Incidentally, the user can change the settings (Filter) of conditions for the event information 114 to be displayed in the event information display area 1200, change the items (Column Settings) to be displayed in the event information display area 1200, and select a desired item and thereby rearrange (or sort) the event information 114 by prioritizing it according to the selected item.

The event information display area 1200 is provided with a selection box 1211 capable of selecting the event information 114 for each piece of event information 114. Furthermore, the event information display area 1200 is provided with a display button 1212 (Show Performance) for displaying the performance information 113 of an infrastructure relating to the event information 114 corresponding to the selected selection box 1211.

(Performance Information Display Area)

The management server 100 outputs performance history of an infrastructure in which the relevant event occurred, and time when the event occurred (step S80). For example, when the event information 114 is selected in the event information display area 1200, the management server 100 generates the screen information to display the performance information display area 1300 capable of displaying, on the display screen 1000, the performance information 113 of the infrastructure relating to the event information 114 selected in the event information display area 1200.

More specifically, the performance information 113 of a physical machine or a virtual machine relating to the event information 114 selected in the event information display area 1200 is displayed as a performance graph 1310 in the performance information display area 1300.

Regarding an initial display of the performance graph 1310, information of a performance type (Metric) in excess of a threshold value during the analysis period is displayed from among the performance information 113 of the physical machine or the virtual machine relating to the event information 114. When there are a plurality of performance types in excess of the threshold value, one performance type is determined in accordance with priorities for the performance types that are set in advance or set by the user. Incidentally, the initial display is not limited to the above-described content and information of the performance type (Metric) that is set by the user may be initially displayed.

Under this circumstance, examples of the performance types of a physical machine include a CPU usage percentage, a memory usage percentage, an average packet reception amount for network ports, an average packet transmission amount for network ports, an average frame reception amount for HBA, an average frame transmission amount for HBA, average time for disk transfer processing, a disk reading speed, a disk writing speed, and a free disk space.

Furthermore, examples of the performance types of a virtual machine includes a CPU usage percentage, a CPU dispatch latency time rate, a CPU usage amount, a memory usage percentage, memory balloons, a memory usage amount, an average packet reception amount for virtual ports, an average packet transmission amount for virtual ports, a rate of a destructed average packet reception amount for virtual ports, a rate of a destructed average packet transmission amount for virtual ports, an average data reception amount for virtual ports, an average data transmission amount for virtual ports, an average reading request for virtual disks, an average writing request for virtual disks, an average reading/writing request for virtual disks, virtual disk reading latency time, virtual disk writing latency time, a virtual disk reading speed, and a virtual disk writing speed.

The performance graph 1310 is provided with time interval lines 1311 at the same time intervals as those for the event-related display area 1100. Under this circumstance, the time interval line 1311 for one hour that is closest to the analysis period is displayed in the initial display of the performance graph 1310. The user can designate a display range of the performance graph 1310 from a drop-down list 1320. In a broader sense, the time interval lines 1311 include at least the time interval line 1311 of a time interval including the selected event information 114 (an event occurrence time interval) from among the time intervals of the event-related display area 1100. Specifically speaking, the time intervals for the performance graph 1310 may be only the event occurrence time interval, include the time interval immediately before the event occurrence time interval, or include the time interval immediately after the event occurrence time interval.

Furthermore, the performance graph 1310 is provided with an event time icon 1312 indicating time when the event of the event information 114 occurred. When such an event time icon 1312 is used, the performance information 113 of the infrastructure can be recognized by associating it with the event information 114.

Accordingly, the event information is collectively displayed on the display screen 1000 with respect to the analysis origin application and each application related to that application, so that the user can promptly recognize the applications and events to be analyzed as a whole. Furthermore, the event information which is collectively displayed can be displayed as a list on the display screen 1000, so that the user can easily check the content of the event regarding which the user wants to check its details. Furthermore, when one piece of event information is selected on the list display, the performance information of an infrastructure (such as a physical machine or a virtual machine) relating to the selected event information is displayed. When the performance information of such an infrastructure is used, the user can recognize a resource which has a problem on the infrastructure side, so that whether a fault in the selected event information is a fault on the application side or a fault on the infrastructure side can be distinguished.

The management system 1 can identify applications related to the analysis origin application and appropriately narrow down the event information as described above, so that the time it takes until a fault is dealt with can be reduced. Furthermore, since the performance information of the infrastructure of the narrowed-down event information can be displayed, whether a fault in the event information is a fault on the application side or a fault on the infrastructure side can be promptly distinguished.

### (2) Other Embodiments

Incidentally, the aforementioned embodiment has been described about the case where the present invention is applied to a management system for managing a plurality of applications; however, the present invention is not limited to this example and can be applied to a wide variety of other management systems.

Furthermore, the aforementioned embodiment has been described about the case where the applications are sorted in the order of the relevance score; the applications are further sorted in the order of the severity score if there are applications with the same relevance score; and the applications are further sorted in the order of the number-of-occurrences score if there are applications with the same severity score. However, the present invention is not limited to this example; and after calculating the relevance score, the severity score, and the number-of-occurrences score, a value obtained by tallying these scores (total score) may be calculated and the applications may be sorted in the order of the total score. In this case, the sequential order to display applications can be determined and displayed with better accuracy by enabling customization by the user, for example, by increasing the weighting of a specified score. Additionally, not all the scores of the relevance score, the severity score, and the number-of-occurrences score may not have to be used and some of these scores may be used.

Furthermore, the aforementioned embodiment has been described about the case where events are identified in the order of the severity score; and the events are further identified in the order of the occurrence time score if there are events with the same severity score; and the events are further identified in the order of the number-of-occurrences score if there are events with the same occurrence time score. However, the present invention is not limited to this example; and after calculating the severity score, the occurrence time score, and the number-of-occurrences score, a value obtained by tallying these scores (total score) may be calculated and an event with the highest value of the total score may be identified. In this case, the event can be identified (extracted) and displayed with better accuracy by enabling customization by the user, for example, by increasing the weighting of a specified score. Additionally, not all the scores of the severity score, the occurrence time score, and the number-of-occurrences score may not have to be used and some of these scores may be used.

Furthermore, the aforementioned embodiment has been described about the case where an application(s) regarding which the score relating to the severity is equal to or more than a threshold value, from among the related applications, is not displayed. However, the present invention is not limited to this example; and an application(s) regarding which the score relating to the relevance is equal to or more than a threshold value (for example, the score corresponding to the layer difference “5” or more) may not displayed or an application(s) regarding which the score relating to the number of occurrences is equal to or more than a threshold value (for example, the score corresponding to the number of occurrences “2” or less) may not be displayed.

Furthermore, the aforementioned embodiment has been described about the case where the management server program 111 generates the screen information for drawing display objects in the layout area; and after the user's operation is performed on the GUI screen, the web browser 211 (or the management client program 212) transmits an instruction to follow the user's operation to the management server program 111. However, the present invention is not limited to this example; and the management server program 111 may transmit at least part of the information stored in itself to the web browser 211 (or the management client program 212) and the web browser 211 (or the management client program 212) may store it as temporary information in the storage resource 205 and the web browser 211 (or the management client program 212) may draw the display objects in the layout area (for example, newly draw, expand, enlarge, or contract the display objects) on the basis of the instruction according to the user's operation and the temporary information. Accordingly, with the management system 1, some of the functions of the management server 100 may be implemented by the management client 200, some of the functions of the management client 200 may be implemented by the management server 100, or all the functions of the management client 200 may be implemented by the management server 100 and the management client 200 may not have to be provided.

Furthermore, the aforementioned embodiment has been described about the case where the processing is executed sequentially in the order of step S20, step S30, step S40, and step S50; however, the present invention is not limited to this example and the weighting may be increased in any arbitrary order.

### REFERENCE SIGNS LIST

1: management system

2: computer system

100: management server

200: management client

300: host

400: storage system

1. A management system for managing a plurality of applications, comprising:
a storage unit that stores event information of events, which have occurred in each of the plurality of applications, and related information indicative of a relation between applications with respect to the plurality of applications;
an input unit that inputs information of an application which is an analysis origin from among the plurality of applications;
an identification unit that identifies applications related to the application, which is the analysis origin, based on the related information stored in the storage unit; and
an extraction unit that extracts the event information of the application which is the analysis origin, and the event information of the related applications from the event information stored in the storage unit.

2. The management system according to claim 1,
further comprising an output unit that outputs the event information extracted by the extraction unit by associating the event information with each of the application, which is the analysis origin, and the related applications.

3. The management system according to claim 2,
wherein the storage unit stores layer information indicative of application layers by associating the layer information with each of the plurality of applications;
wherein the event information stored in the storage unit includes severity information indicative of severity of the events and time information indicative of occurrence time of the events; and
wherein the management system further comprises:
a weighting unit that: calculates each layer difference between the application, which is the analysis origin, and the related applications by referring to the layer information stored in the storage unit and increases weighting of output by the output unit more with respect to an application with a smaller layer difference from the application which is the analysis origin; increases the weighting of the output by the output unit more with respect to an application regarding which an event of higher severity has occurred, on the basis of the severity information of the event information extracted by the extraction unit; increases the weighting of the output by the output unit more with respect to an application regarding which the number of occurrences of events per unit time is larger, on the basis of the event information extracted by the extraction unit;
and increases the weighting of the output by the output unit more with respect to the event information of an event closer to current time on the basis of the event information extracted by the extraction unit; and
a generation unit that generates screen information for the output unit to display the application which is the analysis origin, the related applications, and the event information extracted by the extraction unit in accordance with the weighting by the weighting unit.

4. The management system according to claim 2,
wherein the storage unit stores layer information indicative of application layers by associating the layer information with each of the plurality of applications; and
wherein the management system further comprises a weighting unit that: calculates each layer difference between the application, which is the analysis origin, and the related applications by referring to the layer information stored in the storage unit; and
increases weighting of the output by the output unit more with respect to an application with a smaller layer difference from the application which is the analysis origin.

5. The management system according to claim 2,
wherein the event information stored in the storage unit includes severity information indicative of severity of the events; and
wherein the management system further comprises a weighting unit that increases weighting of the output by the output unit more with respect to an application regarding which an event of higher severity has occurred, on the basis of the severity information of the event information extracted by the extraction unit.

6. The management system according to claim 2,
further comprising a weighting unit that increases weighting of the output by the output unit more with respect to an application regarding which the number of occurrences of events per unit time is larger, on the basis of the event information extracted by the extraction unit.

7. The management system according to claim 2,
wherein the event information stored in the storage unit includes time information indicative of occurrence time of the events; and
wherein the management system further comprises a weighting unit that increases weighting of the output by the output unit more with respect to the event information of an event closer to current time on the basis of the event information extracted by the extraction unit.

8. The management system according to claim 2,
wherein the storage unit stores performance information of an infrastructure where each of the plurality of applications is provided; and
wherein the management system further comprises a generation unit that generates screen information for the output unit to display the performance information of the infrastructure where an application in which an event of the event information selected based on a user's operation has occurred is provided.

9. The management system according to claim 2,
further comprising a generation unit that generates screen information for the output unit to display a list of the event information which is gathered and displayed at a specified time interval based on a user's operation.

10. The management system according to claim 1,
wherein the event information stored in the storage unit includes severity information indicative of severity of the events; and
wherein the extraction unit extracts the event information regarding which the severity information is equal to or more than a threshold value.

11. The management system according to claim 1,
wherein the event information stored in the storage unit includes severity information indicative of severity of the events; and
wherein the management system further comprises an output unit that associates the event information stored in the storage unit with the plurality of applications and outputs information indicative of an event of highest severity with respect to each application.

12. A management apparatus for managing a plurality of applications, comprising:
a storage unit that stores event information of events, which have occurred in each of the plurality of applications, and related information indicative of a relation between applications with respect to the plurality of applications;
an input unit that inputs information of an application which is an analysis origin from among the plurality of applications;
an identification unit that identifies applications related to the application, which is the analysis origin, based on the related information stored in the storage unit; and
an extraction unit that extracts the event information of the application, which is the analysis origin, and the event information of the related applications from the event information stored in the storage unit.

13. A management method for a management apparatus including a storage unit that stores event information of events, which have occurred in each of a plurality of applications, and related information indicative of a relation between applications with respect to the plurality of applications,
the management method comprising:
a first step executed by an input unit inputting information of an application which is an analysis origin from among the plurality of applications;
a second step executed by an identification unit identifying applications related to the application, which is the analysis origin, based on the related information stored in the storage unit; and
a third step executed by an extraction unit extracting the event information of the application, which is the analysis origin, and the event information of the related applications from the event information stored in the storage unit.
